(19) United States
(12) Patent Application Publication
(10) Pub. No.: US 2003/0054811 A1
(43) Pub. Date: Mar. 20, 2003

(54) Method and apparatus for automatic call tests in wireless networks

(75) Inventors: Joseph Han, Irvine, CA (US); Gun Yeob Kim, Tustin, CA (US); Seong Ji Choi, Orange, CA (US); Kyung Ju Lee, Irvine, CA (US)

Correspondence Address: JONATHAN Y. KANG, ESQ., LEE & HONG P.C., 11th Floor, 221 N. Figueroa Street, Los Angeles, CA, 90012-2601, US

(73) Assignee: Willtech International, Inc.

(21) Appl. No.: 09/955,541

(22) Filed: Sep. 18, 2001

(51) Int. Cl. H04Q 7/20

(52) U.S. Cl. 455/423; 379/1.01

(57) ABSTRACT

A methodology to automatically measure network parameters relating to wireless network environments is disclosed. First, if a server's telephone number is detected from power-on registration data stored in a storage device, then a connection with the server is attempted through a mobile station with a data service function using the server's telephone number. Thereafter, if there is test plan from the server after the connection is made, the network parameters is measured using another mobile station with a diagnostic monitor function based on the test plan data. The measured network parameters is then collected and parsed to obtain sets of measured network parameters, each set having a different kind of measured data; and the sets of measured network parameters are transmitted to the server using the mobile station with the data service function when there is a data transmission request from the server or it is time for data transmission.

### BACKGROUND OF THE INVENTION

1. Field of the Invention

The present invention relates to a method and apparatus capable of automatically measuring and reporting network performance in a wireless environment.

2. Description of the Related Art

In a telecommunications system, such as a Code Division Multiple Access (CDMA) system, test measurement equipment is used to evaluate the performance of wireless network. For the performance analysis, the equipment is provided with one or more call test terminals, which are installed in a fixed location or in a moving vehicle (e.g., automobile). By using these call test terminals, it is possible to measure various network parameters relating to wireless network environments and performance within the service coverage area of multiple base stations. The measured network parameters are stored in a database and processed by a server to conduct the performance evaluation.

Currently, to perform the performance evaluation, an operator at a server level initiates the testing by requesting network parameters from the operators at the call test terminals, which measure the network parameters through a mobile station (or handheld device). The mobile station used in the call test terminal has a diagnostic monitor (DM) function, wherein the network parameters are measured in accordance with a test plan issued at the server level. The test plan typically includes information such as a call mode, a test type, call duration, idle time between calls, the test starting time, the test ending time, etc. The call mode indicates whether a mobile station used for the data measurement is in call origination status or call termination status. The test type indicates whether the test was an idle test, call-by-call test or continuous call test, where the idle test represents that the mobile station stays in the idle mode for all time, the call-by-call test represents that the mobile station originates (or terminates) calls and stands by repeatedly, and the continuous call test represents that the mobile station originates a call followed by a specified time duration after every call failure. The network parameters measured according to the test plan are collected and parsed in order to obtain sets of network parameters, each set representing different network parameters.

The collected network parameters include information on date, time, network identification (NID), base station ID (BID), active count, frame error rate (FER) and other diagnostic measurement criteria. The date parameter represents the date on which the network parameters are measured, while the time parameter represents the time at which the network parameters is measured. The date and the time are obtained from a global positioning system (GPS) module that builds in the call test terminal. The NID parameter indicates a network ID and the BID parameter indicates a base station ID that the mobile terminal locks in. The active count represents the number of active pilot signals that correspond to channels that are available for calls and is detected from a status response message from the mobile station.

The measured network parameters are then collected, decoded and converted into the appropriate data format and stored in a storage device for transmission to the server upon the server's request or at the transmission time determined in the test plan. Stored data can be automatically transmitted from the call terminal to the server via another mobile station wirelessly or LAN connection using a predefined transmission protocol.

The sets of network parameters transmitted from the call test terminal are received by the server and stored in the server where the data can be accessed through web browser and evaluated for the performance of the wireless network.

In a conventional call-testing environment, the procedure to measure, collect, parse and then manually transfer the network parameters is entirely manually controlled by the tester's operator. Consequently, the conventional call testing methodology is manual intensive, inconvenient and inefficient. Accordingly, there is a need for an improved testing method that substantially obviates one or more problems due to the limitations and disadvantages of the related art.

### SUMMARY OF THE INVENTION

The primary objective of the current invention is to provide an automatic call test reporting method and apparatus employing a cost-effective and convenient wireless data measurement methodology and tool.

In accordance with the primary aspect of the present invention, there is a provided method and system having at least one call test terminal and a server for automatically measuring network parameters relating to wireless network environments. The test terminal connects automatically to the server when the test terminal is turned on. The test terminal sends to the server its power-on registration data representing a current test state of the test terminal, wherein the power-on registration data contains information indicating a start, interruption or end of the test in the at least one test terminal. If no test plan exists in the test terminal, the test terminal automatically loads a test plan from the server. If the test plan is loaded in the test terminal, the test terminal measures the network parameters according to the test plan; collects and parses the measured network parameters to obtain sets of measured network parameters; and transmits the sets of measured network parameters to the server when there is a data transmission request from the server or a predetermined set time according to the test plan. The data transmission methods are defined for terminals.

In further embodiments, the test terminal is mobile wherein the network parameters are fixed mobile measured by using information representing a position at which the test terminal is currently located in the wireless environment at a test start time included in the test plan.

### BRIEF DESCRIPTION OF THE DRAWINGS

The accompanying drawings, which are included to provide a further understanding of the invention and are incorporated in and constitute a part of this specification, illustrate embodiments of the invention and, together with the description, serve to explain the principles of the invention. The above and other objects and features of the present invention will become apparent from the following description of the preferred configuration given in conjunction with the accompanying drawings, in which:

FIG. 1 provides a block diagram of the novel performance evaluation equipment in accordance with the present invention;

FIG. 2 presents a block diagram of the call test terminal shown in FIG. 1 in accordance with the preferred embodiments of the present invention;

FIG. 3 depicts a detailed block diagram of the control processor shown in FIG. 2 in accordance with the preferred embodiments of the present invention;

FIG. 4 represents a block diagram of server module, which consists of several server components in accordance with the preferred embodiments of the present invention;

FIG. 5 represents the procedure for the call test terminal that automatically measures network parameters pertaining to a wireless network environment and transfers them to the server in accordance with the preferred embodiments of the present invention; and

FIGS. 6A and 6B represent the server procedure that automatically saves network parameters in a database, sends the alarm list and network analysis reports to users by email, and show the current network status on web pages in accordance with the preferred embodiments of the present invention.

### DETAILED DESCRIPTION OF THE PREFERRED EMBODIMENTS

Reference will now be made in detail to the preferred embodiments of the present invention, examples of which are illustrated in the accompanying drawings.

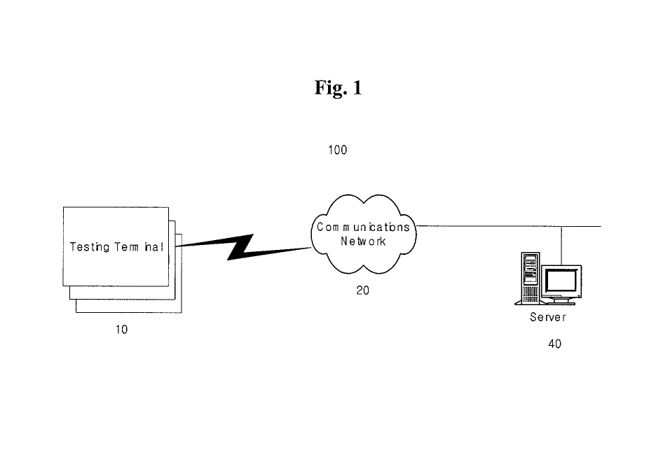

FIG. 1 depicts a block diagram of the performance evaluation system incorporating therein one or more call test terminals in accordance with the preferred embodiments of the present invention. These call test terminals 10 (fixed terminal) can be installed at any fixed location in a wireless network. Alternatively, the call test terminals 10 (mobile terminal) may be installed in moving objects, e.g., a vehicle. From these call test terminals 10, various network parameters relating to the wireless network environment within the service coverage area of multiple base stations can be measured (even in the case where the call test terminals 10 are moving). Thus, the performance evaluation system to automatically measure the network parameters and evaluate the performance of the base stations using the measured network parameters can be performed.

According to the preferred embodiments of the present invention, when there is a test request from a server module 40 or it is time to start to measure according to test plan that specified from the server 40, network parameters relating to wireless network environments within the service coverage area of multiple base stations are automatically measured from the call test terminals 10. After measuring the network parameters, they are automatically sent to server module 40 through a communications network 20. Therefore, the system 100 does not require operators for the call test terminals 10; and, thus, it is more efficient, cost-effective and convenient.

In accordance with the preferred configuration of the present invention, the system 100 is capable of measuring network parameters while transmitting the measured data to server module 40. Each call test terminal 10 uses a mobile station with a data service function and another mobile station with a DM function.

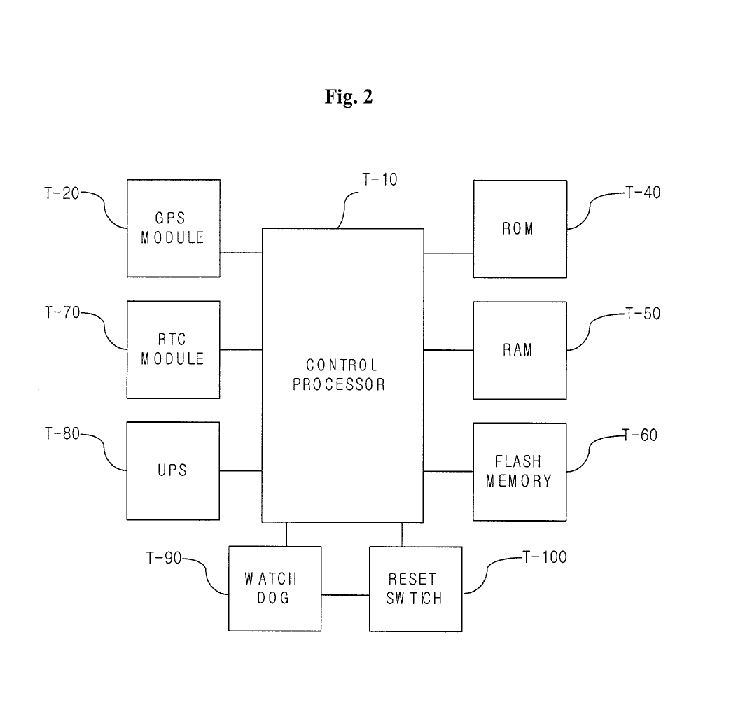

FIG. 2 illustrates a block diagram of a call test terminal 10, as depicted in FIG. 1 in accordance with the preferred embodiments of the present invention. The call test terminal 10 includes a control processor 110, a GPS module 120, a read only memory (ROM) 140, a random access memory (RAM) 150, a real-time clock (RTC) 170, an uninterruptible power supply (UPS) 180, a watch-dog 190, a reset switch 200.

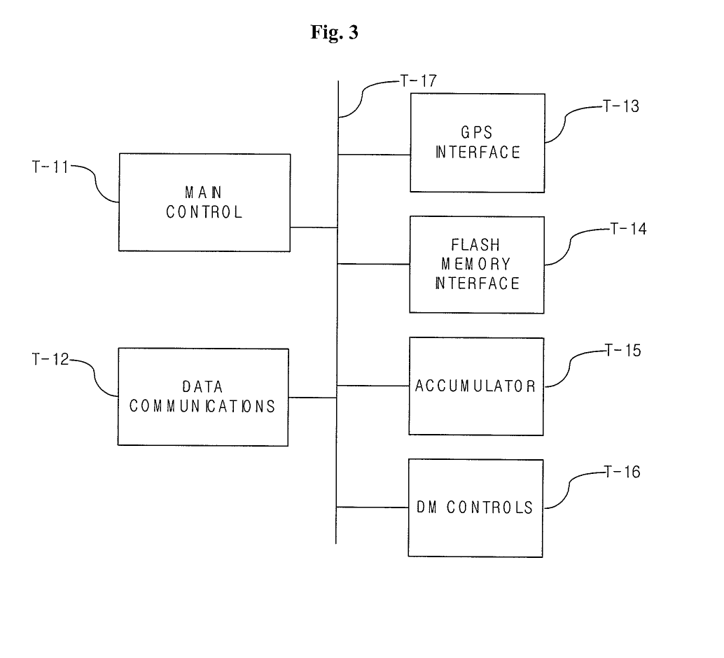

The control processor 110 is a main processor to control the operation of all devices in the call test terminal 10 and manages communication with the server module 40. Also, the processor 110 controls the operation of the mobile stations associated with the call test terminal 10. Additional details of the operation in the processor 110 are discussed below in accordance with FIG. 3. The GPS module 120 provides data including GPS time and terminal location periodically to the control processor 110.

The ROM 140 stores the operating system (OS) and the system program. The ROM 140 automatically loads the system kernel and the application program to the RAM 150 when power is supplied to the test terminal 10. The flash memory 160 stores all network parameters during call test. This data is then transmitted to the server module 40 through the communications network 20 automatically. Memory 160 may also be used as a space for the remote upgrade of software programs embedded in test terminal 10 when users download the new version of terminal software. Further, the memory 160 stores power-on registration data representing a current test state and provides this data to software programs when requested. The power-on registration data includes information indicating a start, interruption, end of the test in the test terminal 10, a server's telephone number and other related data.

The RTC 170 provides the terminal 10 with the correct time information as back-up when GPS 120 fails to provide timing information. As GPS 120 acquired time information from satellites, the control processor 110 sets the time information of RTC 170 based on GPS time. RTC 170 includes NV (non-volatile) memory that will store the time and reason when the terminal 10 stops operating. These stored data in NV memory will be utilized for debugging purpose of terminal 10. When a power cutoff occurs, the UPS 180 supplies power to terminal 10 until all data in RAM 150 is written in flash memory 160. The watchdog 190 monitors the software performing functions of call test terminal 10 with the control processor 110. When the software program run in abnormal conditions, the reset switch 200 will restart automatically the test terminal 10.

FIG. 3 depicts a detailed block diagram of the control processor 110 in accordance with the preferred embodiments of the present invention. The processor 110 includes a main controller 211, a data communications interface 212, a GPS interface 213, a flash memory interface 214, an accumulator 215, and a DM controller 216. The main controller 211 is used to control the operation of the entire system as well as the other control processor components 212, 213, 214, 215, 216 in the processor 110. A data bus 217 is used to communicate data and/or messages among the control processor components 211, 212, 213, 214, 215, and 216.

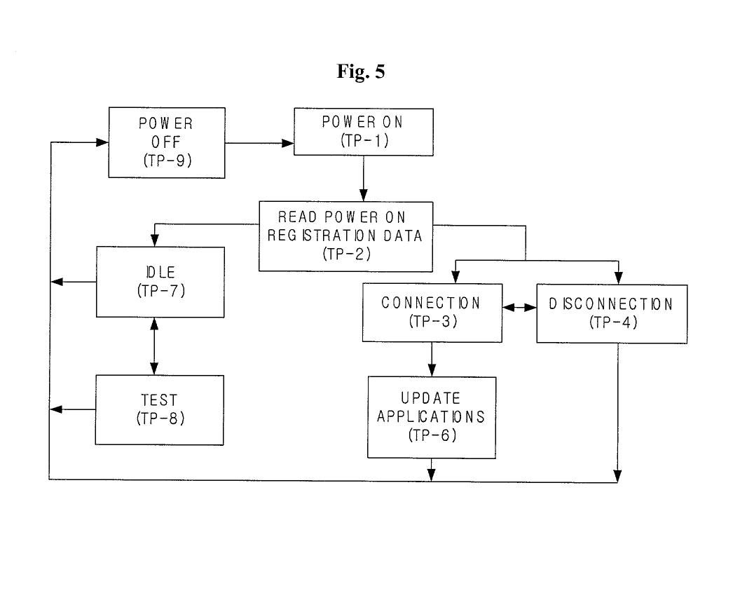

In the described embodiments, the main controller 211 directs a DM controller 216 to start a test for measuring network parameters according to the test plan issued at the server module 40 and triggers the data communications interface 215 to send network parameters when a test ends. Details of the test plan and the measured network parameters will be given when describing the whole procedure of the present invention with reference to FIG. 5. According to a log-mask that is defined from the Road call plan, the DM controller 216 periodically sends a DM data request to the mobile station with the DM function and serves to control calls involving the mobile stations, as well as call origination and release in accordance with the test plan. The DM controller 216 also interacts with the accumulator 215 to collect necessary parameters. The accumulator 215 parses and converts data from the mobile station into an appropriate data format and relays them to the flash memory interface 214. The raw data from the mobile station may be saved without modification by the accumulator 215. The flash memory interface 214 saves all of measured network parameters until they are transmitted to the server module 40 and stores the test plan and applications from the server module 40.

The data communications interface 212 executes access to the server module 40 through the mobile station with the data service function when there is a data transmission request from the server module 40 or it is time for the data transmission. When the access process has been completed, the data communications interface 212 sends the measured network parameters stored in the flash memory 214 to the server module 40 using a predetermined well-known data transmission protocol. To be more specific, the data communications interface 212 first turns on the power of the mobile station with the data service function and controls the mobile station in order to connect it to a Remote Access Server (RAS) which would contain a modem pool (not shown) or directly to the data network of the cellular service provider. Once the IP connectivity is established the data would be transferred to server module 40. When connected, the data communications interface 212 waits until there is a data transmission request from the server module 40. When the communications interface 212 receives the request or at the specified time defined by plan, the communications interface 212 transmits the measured network parameters to the server module 40. The data communications interface 212 performs the remote upgrade of applications in the call test terminal 10 by receiving applications from server 40 and storing them into the flash memory 214. The test plan is also received from server 40 through the communications interface 212 and saved by the flash memory interface 214. Finally, the GPS interface 213 receives and converts the position data and the current time data from the GPS module 120 to data with a preset format.

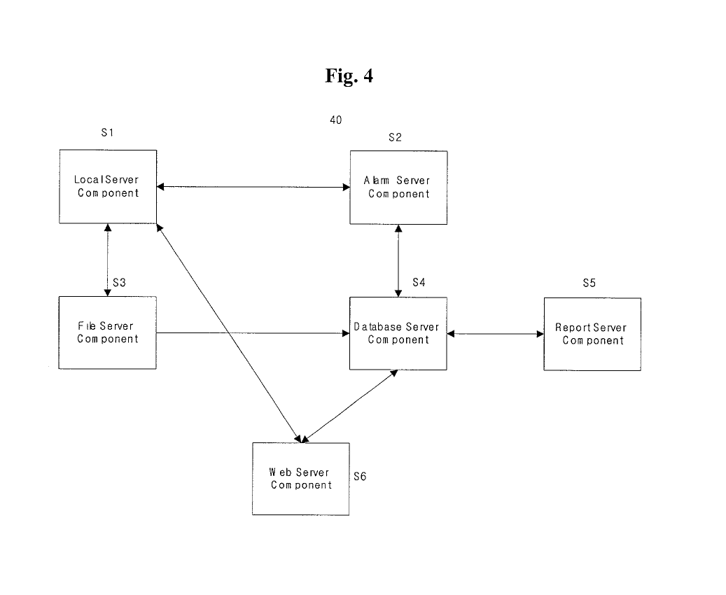

FIG. 4 depicts a detailed block diagram of the server module 40 shown in FIG. 1 according to the preferred embodiments of the present invention. The server module 40 has several server components—local server components S1, alarm server component S2, file server component S3, database server component S4, report server component S5 and web server component S6. Each server component has its own role to process collected data from the call test terminals 10. These server components S1, S2, S3, S4, S5, and S6 are connected logically and may or may not be physically connected so that all server components can be installed either in a single server machine or several servers. Even though this is not shown in FIG. 4, for simplicity, it should also be noted that the server 40 is interfaced with the RAS network device which controls incoming calls, termination calls, data communications between test terminal 10 and server utilizing analog telephone lines or modems. Details of the RAS will be provided when explaining the procedure of the present invention with reference to FIG. 5.

Local server component S1 directly commands and controls the call test terminals 10. Preferably, the local server component S1 communicates with the call test terminals 10 through the RAS. The local server component S1 sends control commands, test plan and terminal software to the terminal 10 by making calls to terminals using RAS. Local server component S1 also receives current network status and data files that contain network parameters from terminals 10. Once local server component S1 has successfully received data files, it relays them to the file server component S3.

According to the preferred embodiments, the alarm server component S2 requests database server component S4 for a user list and stores the list. Alarm server component S2 also requests local server component S1 for current network status. Alarm server component S2 examines network status to determine whether current network status meets alarm conditions or not. Alarm conditions can be specified by users through web server component S6. If the current network status is in any alarm conditions, alarm server component S2 generates the alarm report and sends the report to all users in the user list received from database server component S4 respectively by email. Alarm server component also sends alarm records to database server component S4 to store alarm history.

File server S3 receives data files from local server S1 and stores it in a local storage subsystem comprised of one or more disks. When the file server component S3 has stored data files, it reads the summary information of data files along with detailed network parameters and then sends this information as well as detailed network parameters to the database server S4.

Database server component S4 receives the summary information and detailed network parameters from file server component S3 and stores it in a relational database. The stored information is used as the source for report server S5 to generate network analysis reports written in HTML. Database server component S4 stores the alarm history for terminals 10 from alarm server component S2. This history can be shown later on web pages through the web server component S6.

Report server component S5 requests database server component S4 for information of network parameters based on user-specified time period, terminal group(s) and geographic zone. Report server component S5 generates network analysis reports written in HTML and sends them to the registered users by email. The report server component S5 can generate various network analysis reports that include statistics over a specified time interval as well as trends over time (e.g. daily, weekly or monthly).

Web server component S6 provides the user interface for all server components mentioned above. Web server component S6 receives user inputs, sends them to each server component and shows responses from each server component on web pages. It allows the user to operate the system and see the result of network performance evaluation including current network status, network analysis report written in HTML, etc.

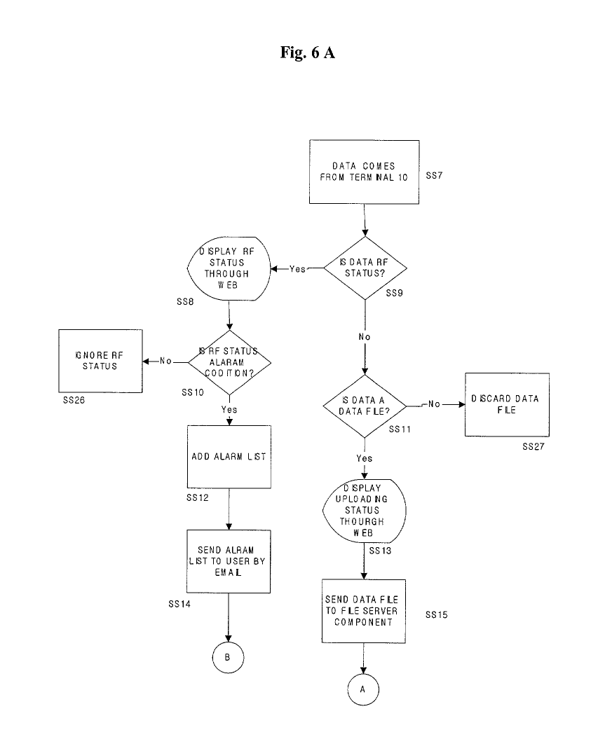

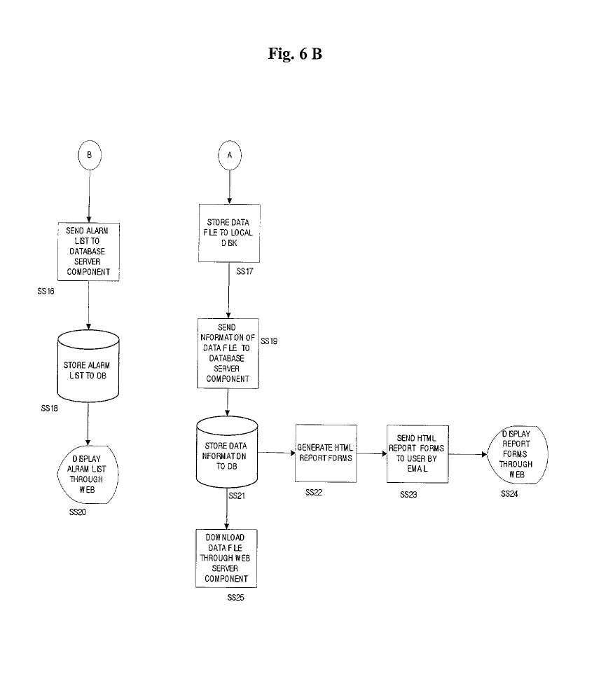

FIGS. 5 and 6A and 6B describe the logic for automatically measuring certain network parameters relating to wireless network environments and sending them to the local server component in accordance with the preferred embodiments of the present invention. The process of the present invention is initiated when power is supplied to the call test terminal 10. Specifically, when the call test terminal 10 is powered up at step TP- 1, the main controller 211 of the control processor 110 reads the power-on registration data stored in the flash memory interface 214 at step TP-2. Once a telephone number of the local server component S1 in FIG. 4 is detected from the power-on registration data, then at step TP-2 the communication interface 212 attempts a connection with local server component S1 using the mobile station with the data service function. If the communications interface 212 fails to make a connection with local server component S1, the communication interface disconnects the connection attempt at step TP-4, and reattempts the connection at step TP-3. If the connection cannot be made after a predetermined number of times, the main controller switches the power off at step TP-9 and attempts to start the connection process over at step TP-1.

Once the connection has been made, at step TP-3 the communications interface 212 sends the server 40 the power-on registration data together with the position data; and waits until instructions are sent from the server 40. After sending the above data, if the test plan is received by the communications interface 212, at step TP-3 the test plan is extracted and stored in the flash memory 160 together with the position data and current time data issued from the GPS module 120. The test plan may preferably include data indicating a call mode, test type, calling time, idle time, call count, start time, etc. If the local server component does not have any new application software to download to the call test terminal 10, the communication interface 212 disconnects from the server 40 and remains in idle mode at step TP-7 until the test plan start time. However, if the local server component S1 has upgraded software applications for the test terminal 10 at step TP-5, the communication interface 212 receives the updated applications at step TP-6. After the communication interface 212 finishes the download of applications, the communication interface 212 and the main controller 211 enters in the power off state (at step TP-9), and then the test terminal 10 restarts in the power on state (at step TP-1) to initiate the new applications in the call test terminal 10.

The call mode data and the test type data are the same as those explained in the “Background of the Invention,” and therefore, details thereof are omitted here. The calling time represents the interval of time during which a call is continued in the call-by-call state and the idle time indicates the interval of time during which no call is originated in the idle state. The call count represents the total number of incidents of the call origination and termination and the start time data represents a test start time.

Once the designated test plan start time is reached, the main controller 211 starts to measure network parameters through the mobile station with the DM function according to the test plan at step TP-8, and returns to idle mode after the test ends according to the test plan. The network parameters measured according to the test plan is collected and parsed to obtain sets of measured network parameters, each having a different kind of measured network parameters. As fully described above, the control processor components 216, 215, 214, 211 are used to measure, gather and parse the network parameters and obtain the sets of measured network parameters.

The measured network parameters include date, time, call count, test type, call fail, call drop, fail reason, network ID (NID), BID, SID, channel number, pseudo-noise (PN) offset of pilot signal, Ec/Io, call setup time, calling holding time, data count, latitude, longitude, active count, candidate count, neighbor count, best PN & Ec/Io, Rx power, Tx power adjust, channel state, call event, FER, Layer 2 & 3 messages, etc. The test type, date, time, NID, BID, calling time, active count, and the FER data are the same as those explained above and in the “Background of the Invention”, and, therefore, details of thereof are omitted here. The remaining terms will be explained below.

The fail reason data describes a failure reason in the event of call failure and may be obtained from a status response message from the mobile station with the DM function. The PN offset represents pilot signals with the amounts of different delay and may also be obtained from the status response message. The Ec/Io indicates Ec/Io of the pilot signals with the amounts of different delay and may be derived from a power value in the status response message. The call setup time represents a time duration starting from input of a telephone number to make a call to receipt of a ring back signal (or end-to-end connection for data calls), i.e., to a time at which the call is made. The call holding time represents a time duration from the call setup to the call complete (i.e. hung up the call). The data count indicates the number of the different kinds of measured network parameters as mentioned above.

Latitude and longitude indicate latitude and longitude of the terminal 10 at its currently position in the system 100, respectively, and may be obtained through the GPS interface block T-13 from the GPS module T-20. The candidate count indicates the number of candidate pilot signals that can be used as active pilot signals and may also be obtained from the status response message. The neighbor count represents all pilot signals except the active and the candidate pilot signals and may also be derived from the status response message.

The best PN & Ec/Io describe PN and Ec/Io of the best active pilot signal among the active pilot signals respectively, and may also be obtained from the status response message. The Rx and Tx power data represent a receiving power and a transmitting power, respectively, and may also be obtained from the status response message. The Tx power adjust data represents a reference signal used to adjust the transmitting power and may be derived from a temporal analyzer graph response from the mobile station. The channel state represents a status of a channel through which the service is being made. The call event represents a status of call and may be obtained from the call mode data.

If the test process has successfully been completed, then the sets of measured network parameters are logged into the flash memory T-60 for transmission to S1. The completion of the process, for example, may be detected by monitoring and counting the repeated number of times of the call-by-call test and the idle test.

After the test plan is completed, the communications interface 212 (at step TP-10) attempts a connection with local server component S1 according to the test plan. When the connection is made, the communications interface 212 informs the server 40 of the power-on registration data and waits until there are any further instructions from the local server component S1. After receiving data request instructions from the server 40, the communications interface 212 starts to transmit the sets of measured network parameters stored in the flash memory 160 to the server 40 through the components coupled there between. When the data transmission is completed, the communications interface 212 cuts off the connection with the server 40 and remains idle at step TP-7. However, if after sending the power-on registration data, there are data cancel instructions from the server 40, the main controller 211 may eliminate all data logged into the flash memory 160 and the communication interface 212 will cut off the connection with the server 40.

The test terminal 10 is always in the power on position, but may be in power off mode by mistake due to an instantaneous power failure. In addition, if the test process is interrupted due to a disruption of the supply of the power to the test terminal 10 during the test operation at step TP-8, all measured data is stored in the flash memory 160 and is sent to the server 40 immediately at step TP-9. Further, if a disconnection occurs in the communications with the server 40 during the uploading of the sets of measured network parameters at the step TP-10, the process may return to step TP-4 and then may attempt a connection with the server 40. If the connection has been made, the communications interface 212 informs the server 40 of the power-on registration data including the disconnection information at step TP-4. Thereafter, if there are data resending request instructions from the server 40, the communications interface 212 resends the sets of measured network parameters to the server 40 at step TP-3 and cuts off the connection with the server 40; and then also returns to step TP-4 to remain in the disconnect state. However, if the power to the terminal 10 is off during the transmission of the sets of measured network parameters, it is possible to resend the same to the server 40 only when the power is restored to the terminal 10.

FIGS. 6A and 6B describes the detail flow of data processing in the server 40. When data arrives from terminal 10 at step SS7, a determination is made whether the data is network status information (i.e. RF status) or data files (at step SS8). If the data is RF status information, the data is shown graphically on a web page by web server component S6 at step SS8. The alarm server component S2 checks whether the network status is in alarm condition at step SS10. If network status is in alarm condition, alarm server component S2 adds this network status into an alarm list at step SS12 and sends the alarm list to the registered users by email at step SS14. Alarm server component S2 also transmits the alarm list to database server component S4 at step SS16. Database server component S4 receives the alarm list and stores it into the relational database at step SS18 for later use. This stored alarm list can be shown on a web page at step SS20 by web server component S6 upon user's request. If network status is not in alarm condition, the alarm server component S2 discards the network status information at step SS26.

If the data from terminal 10 is non-network status information, local server component S1 sees whether it is a data file that contains network parameters at step SS11. If the data came from terminal 10 is a file, the process goes to the step SS13. Otherwise, local server component S1 ignores the data from terminal 10 at step SS27. If the data is a recognizable file at step SS11, web server component S6 shows the status of file uploading status on a web page at step SS13 and local server component S1 starts to transmit the file to the file server component S3 at step SS15. If the file is not recognizable, local server component S1 at step SS27 ignores the received file from terminal 10.

The file server component S3 receives files and stores it into the local disk at step SS17. The file server component S3 reads the information of files and sends the information to database server component S4 at step SS19. The database server component S4 stores the information that contains the full path of file, summary information of network parameters and the detailed network parameters at step SS21. Then, the web server component S6 allows user to download files at step SS25 by querying the fall path of the file in database server component S4.

Report server component S5 generates network analysis reports written in HTML, using the detailed network parameters stored in relational database of database server component S4 at step SS22. Report server sends these generated HTML network analysis reports to the registered users by email at step SS23. The user can also access these network analysis reports written in HTML through the web server component S6 at step SS24 any time and anywhere an Internet connection is available. The web server component S6 also provides an interface to the local server component S1 for a user to input the test plan and to download terminal software (i.e. control commands) to the test terminals 10. Thus, local server component S1, by establishing a connection to the test terminals 10, can send the user inputted control commands to the test terminals 10.

As described above, this invention provides simple methods for measuring network parameters automatically and viewing the various reports of network performance evaluation on web pages or via email. The invention is very cost effective and reduces efforts and time to evaluate network parameters in comparison to the existing methods and tools. While the present invention has been shown and described with respect to the particular components, it will be apparent to those experienced with network test tools that many changes and modifications may be made without departing from the spirit and scope of the invention as defined in the appended claims.

The preferred embodiments may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

The logic implementation of FIGS. 4, 5, and 6A and 6B described specific operations as occurring in a particular order. In alternative implementations, certain of the logic operations may be performed in a different order, modified or removed and still implement preferred embodiments of the present invention. Moreover, steps may be added to the above described logic and still conform to implementations of the invention.

Therefore, the foregoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method for automatically measuring network parameters relating to wireless network environments with a server and at least one test terminal, comprising the steps of:
connecting to the server when the test terminal is turned on;
sending power-on registration data representing a current test state of the test terminal, wherein the power-on registration data contains information indicating a start, interruption or end of the test in the at least one test terminal; and
if no test plan exists in the test terminal, automatically loading a test plan from the server;
if the test plan is loaded in the test terminal, measuring the network parameters according to the test plan; collecting and parsing the measured network parameters to obtain sets of measured network parameters; and transmitting the sets of measured network parameters to the server when there is a data transmission request from the server or a predetermined set time according to the test plan.

2. The method of claim 1, wherein the test terminal is installed in a fixed location.

3. The method of claim 1, wherein the test terminal is mobile.

4. The method of claim 3, wherein the network parameters are measured by using information representing a position at which the test terminal is currently located in the wireless environment at a test start time included in the test plan.

5. The method of claim 4, wherein position information is obtained from a global positioning system associated with the test terminal.

6. The method of claim 1, wherein the test terminal has a mobile station with a diagnostic monitor function to measure the network parameters and a mobile station with a data service function to communicate data with the server.

7. The method of claim 1, wherein the step of collecting and parsing the measured network parameters further comprise decoding and storing the measured network parameters in a storage device.

8. The method of claim 7, wherein the step of transmitting the sets of measured network parameters further comprise:
turning on a mobile station with a data service function and connecting with the server using a modem or a RAS connection; and
sending the sets of decoded measured network parameters stored in the storage device to the server through the mobile station with the data service function.

9. The method of claim 1, wherein the wireless network environment is a CDMA system.

10. The method of claim 1, further comprising:
downloading updated application programs to the test terminal from the server when the test terminal is initially connected to the server.

11. A system for automatically measuring network parameters relating to wireless network environments with a server and at least one test terminal, comprising:
means for connecting to the server automatically when the test terminal is turned on;
means for sending power-on registration data representing a current test state of the test terminal, wherein the power-on registration data contains information indicating a start, interruption or end of the test in the at least one test terminal; and
if no test plan exists in the call test terminal, means for automatically loading a test plan from the server;
if the test plan is loaded in the test terminal, means for measuring the network parameters according to the test plan; means for collecting and parsing the measured network parameters to obtain sets of measured network parameters; and means for transmitting the sets of measured network parameters to the server when there is a data transmission request from the server or a predetermined set time according to the test plan.

12. The system of claim 11, wherein the test terminal is installed in a fixed location.

13. The system of claim 11, wherein the test terminal installed in a moving object.

14. The system of claim 13, wherein the network parameters are measured by using information representing a position at which the test terminal is currently located in the wireless environment at a test start time included in the test plan.

15. The system of claim 14, wherein the position information is obtained from a global positioning system associated with the call test terminal.

16. The system of claim 11, wherein the test terminal has a mobile station with a diagnostic monitor function to measure the network parameters and a mobile station with a data service function to communicate data with the server.

17. The system of claim 11, wherein the collecting, parsing and transmitting means includes means for decoding and storing the collected network parameters in a storage device.

18. The system of claim 11, wherein the transmitting means further comprise:
means for turning on a mobile station with a data service function and connecting with the server using a modem or a RAS connection; and
means for sending the sets of decoded measured network parameters stored in the storage device to the server through the mobile station with the data service function.

19. The system of claim 11, wherein the wireless network environment is a CDMA system.

20. The system of claim 11, further comprising:
means for downloading updated application programs to the test terminals from the server when the test terminal is initially connected to the server.

21. The system of claim 11, wherein the server further comprises:
means for handling data input and output from a web based user interface; and
means for transferring to the test terminal control commands including the test plan and terminal software received through the web based user interface.

22. The system of claim 11, wherein the server further comprises:
means for showing current RF status coming from the test terminal;
means for sending alarm list generated based on RF status coming from the terminal to users by email;
means for showing current data transmission status between the test terminal and the server on a web based user interface; and
means for sending HTML RF analysis reports generated by analyzing the collected network parameters stored in a database.

23. An article of manufacture containing code for automatically measuring network parameters relating to wireless network environments having a server and at least one test terminal, comprising a computer usable media including at least one computer program embedded therein that is capable or causing at least one computer to perform:
connecting to the server automatically when the test terminal is turned on;
sending power-on registration data representing a current test state of the test terminal, wherein the power-on registration data contains information indicating a start, interruption or end of the test in the at least one test terminal; and
if no test plan exists in the test terminal, automatically loading a test plan from the server;
if the test plan is loaded in the test terminal, measuring the network parameters according to the test plan; collecting and parsing the measured network parameters to obtain sets of measured network parameters; and transmitting the sets of measured network parameters to the server when there is a data transmission request from the server or a predetermined set time according to the test plan.
